(19) United States
(12) Patent Application Publication
(10) Pub. No.: US 2025/0292224 A1
(43) Pub. Date: Sep. 18, 2025

(54) CROSS-CHAIN TRANSACTING WITH DRAG-AND-DROP MECHANISMS

(71) Applicant: Ava Labs, Inc., Brooklyn, NY (US)

(72) Inventors: Connor Chevli, Washington, DC (US); Akash Gupta, New York City, NY (US); Kevin Sekniqi, Miami, FL (US)

(21) Appl. No.: 19/080,272

(22) Filed: Mar. 14, 2025

Related U.S. Application Data
(60) Provisional application No. 63/565,736, filed on Mar. 15, 2024.

(51) Int. Cl. G06Q 20/12; G06F 3/0486; G06Q 20/38

(52) U.S. Cl. CPC G06Q 20/123; G06F 3/0486; G06Q 20/389; G06Q 2220/00

(57) ABSTRACT

Disclosed are techniques for transferring digital assets across networks using drag-and-drop functionality in a user interface (UI). A method includes: receiving user input to select a visual representation of a digital asset in a first network region of the UI, determining, based on the user input, a digital asset associated with a user to be transferred, receiving user input indicating a drag action of the selected visual representation across another region of the UI, determining, based on the user input, the user is initiating a transfer of the digital asset from a first network associated with the first network region, receiving, user input indicating a drop action of the selected visual representation in a second network region of the UI, determining, based on the user input, the transfer is initiated from the first network to a second network associated with the second network region, and returning instructions for transfer execution.

### CROSS-REFERENCE TO RELATED APPLICATIONS

This application claims the priority benefit of U.S. Provisional Patent Application No. 63/565,736, filed Mar. 15, 2024, which is incorporated herein by reference in its entirety.

### TECHNICAL FIELD

This disclosure generally describes devices, systems, and methods related to systems, methods, techniques, and graphical user interfaces (GUIs) for performing cross-chain transactions with drag-and-drop mechanisms.

### BACKGROUND

Users can perform transactions across different blockchains, which can be referred to as cross-chain transactions. For example, a user can transfer cryptocurrency from a first blockchain to a second blockchain. To perform and complete the cross-chain transactions, the user may interact with complex GUIs at their device. Using those GUIs, the user can be required to perform multiple steps, including but not limited to selecting networks, specifying token amounts to transfer, and confirming the transfer/transaction(s). These steps can be performed across various modal windows presented at the user's device.

Bridges can be established between blockchains to facilitate users performing cross-chain transactions. Many bridges, such as centralized and decentralized bridges, may require the transacting users to have technical understandings of blockchain technology in order to perform necessary steps to execute the cross-chain transactions. For example, some bridges use a traditional point-and-click interface for the user to select tokens and specify a destination chain for the selected token. This process can be error-prone and intimidating for users who may not be familiar with some of the intricacies of blockchain technology. Moreover, requiring the user to manually enter information for the cross-chain transaction in the interface can increases risk of mistakes, such as sending tokens to a wrong chain, which can lead to loss of funds or need for technical recovery processes.

### SUMMARY

The disclosure generally describes systems, methods, techniques, and technology for enabling cross-chain transactions using drag-and-drop mechanisms in GUIs presented at a user device. More specifically, a GUI for a bridge, such as a cryptocurrency bridge, can be presented at a user device that allows the user to easily and accurately perform cross-chain transactions. The GUI can include drag-and-drop functionality to allow for the user to easily drag a visual representation of tokens or digitial assets from a first blockchain and drop the visual representation of the tokens onto a second blockchain, the second blockchain being a destination chain for the user's cross-chain transaction. In some implementations, the drag-and-drop functionality can allow the user to drag a visual representation of a chain or subnet into a region in the GUI that represents the source chain and drag a visual representation of a second chain or subnet into a second region in the GUI that represents the destination chain. Once the user input is provided for such drag-and-drop functionality, a backend computing system can automatically populate necessary transaction details for the user to review before submitting and completing the transaction. As a result, the user may not have to interact with multiple GUIs or modal windows and perform various steps to establish, submit, and complete the cross-chain transaction.

Although the disclosed techniques are described for transferring digital assets between blockchains, other illustrative implementations are also possible. For example, the disclosed techniques can be used to transfer digital assets between subnets. As another example, the disclosed techniques can be used to transfer digital assets between a subnet and a blockchain. Various other implementations are also possible, as described further in this document.

One or more embodiments described herein can include method for transferring digital assets across networks using drag-and-drop functionality in a user interface (UI), the method including: generating and executing, at a client device, instructions to present a bridge UI with drag-and-drop functionality enabled in a GUI display at the client device, receiving, at the client device, user input indicating selection of a visual representation of a digital asset in a first network region of the bridge UI, determining, by the client device and based on the user input indicating selection of the visual representation of the digital asset, a digital asset associated with a user to be transferred, receiving, at the client device, user input indicating a drag action of the selected visual representation of the digital asset from the first network region of the bridge UI across another region of the bridge UI, determining, by the client device and based on the user input indicating the drag action, that the user is initiating a transfer of the digital asset associated with the user from a first network associated with the first network region of the bridge UI, receiving, by the client device, user input indicating a drop action of the selected visual representation of the digital asset in a second network region of the bridge UI, determining, by the client device and based on the user input indicating the drop action, that the transfer of the digital asset associated with the user is initiated from the first network to a second network associated with the second network region of the bridge UI, and generating and returning, by the client device, instructions to execute the transfer of the digital asset associated with the user.

In some implementations, the embodiments described herein can optionally include one or more of the following features. The method can also include returning, by the client device and for presentation in the bridge UI, information indicating completion of the transfer of the digital asset associated with the user. The method can also include determining, by the client device and based at least in part on the user input, transaction details for the transfer of the digital asset associated with the user. The method can also include returning, by the client device and for presentation in the bridge UI, the transaction details, the transaction details being presented in a modal window that can visually overlay at least a portion of the bridge UI, receiving, by the client device, user input indicating approval of the transaction details, and performing the generating and returning operation based on receiving the user input indicating approval of the transaction details. Sometimes, determining, at the client device and based at least in part on the user input, transaction details for the transfer of the digital asset associated with the user can include: accessing, using one or more APIs, digital asset information and user information, performing, based on processing the accessed information, one or more checks to determine whether the user has sufficient resources to perform the transfer of the digital asset associated with the user, and auto-populating, based on a determination that the user has the sufficient resources and further based on the accessed information, the transaction details.

As another example, generating and returning, by the client device, instructions to execute the transfer of the digital asset associated with the user can include returning the instructions to a backend computer system that can be configured to use a bridge technology associated with the bridge UI to transfer the digital asset associated with the user from the first network to the second network. The method can also include applying, by the client device, highlighting to a perimeter of the second network region in the bridge UI in response to receiving the user input indicating the drag action of the selected visual representation of the digital asset to the second network region in the bridge UI. The method may include removing, by the client device, the highlighting to the perimeter of the second network region in the bridge UI in response to receiving the user input indicating the drop action of the selected visual representation of the digital asset in the second network region in the bridge UI. Generating and returning, by the client device, instructions to execute the transfer of the digital asset associated with the user can also include identifying a bridging protocol to bridge the first and the second networks, the instructions including the identified bridging protocol.

In some implementations, the digital asset can be a token. The digital asset can be a cryptocurrency. The first network and the second network can be first and second blockchains. The first network and the second network can be first and second subnets. The first and second subnets can be part of a same blockchain. The first and second subnets can be part of different blockchains. The first network can be a blockchain and the second network can be a subnet. The subnet can be part of the blockchain. The subnet can be part of a different blockchain. The first network can be a subnet and the second network can be a blockchain. The subnet can be part of the blockchain. The subnet can be part of a different blockchain. The user input can include audio commands. The user input can include touch feedback.

One or more embodiments described herein can include a method for transferring digital assets across networks using drag-and-drop functionality in a user interface (UI), the method including: generating and executing, at a client device, instructions to present a bridge UI with drag-and-drop functionality enabled in a GUI display at the client device, receiving, at the client device, first user input indicating selection of a visual representation of a first network in the bridge UI, a drag action of the selected visual representation of the first network across the bridge UI, and a drop action of the selected visual representation of the first network in a source network region of the bridge UI, determining, by the client device and based on the first user input, a first network associated with a user from which to initiate a digital asset transfer, receiving, at the client device, second user input indicating selection of a visual representation of a second network in the bridge UI, a drag action of the selected visual representation of the second network across the bridge UI, and a drop action of the selected visual representation of the second network in a destination network region of the bridge UI, determining, by the client device and based on the second user input, a second network associated with the user for which to receive the digital asset transfer, determining, by the client device and based at least in part on the first and second user input, transaction details for the transfer of the digital asset between the first network and the second network, and generating and returning, by the client device and based on the transaction details, instructions to execute the transfer of the digital asset between the first network and the second network.

The method can optionally include one or more of the abovementioned features and/or one or more of the following features. For example, the method can also include returning, by the client device and for presentation in the bridge UI, the transaction details, receiving, by the client device, user input indicating approval of the transaction details, and performing the generating and returning operation in response to receiving the user input indicating the approval of the transaction details. The transaction details can be presented in a modal window that can visually overlay at least a portion of the bridge UI. The method can also include returning, by the client device and for presentation in the bridge UI, information indicating completion of the transfer of the digital asset between the first network and the second network.

The devices, system, and techniques described herein may provide one or more of the following advantages. For example, the disclosed technology can reduce complexity and avoid user experience (UX) shortcomings of existing bridge interfaces by providing intuitive, easy-to-use drag-and-drop mechanisms for cross-chain transactions. The disclosed drag-and-drop mechanisms can greatly simply cross-chain transaction processes, thereby making them more accessible and less prone to user error. By enabling users to visually drag their cryptocurrency tokens from one chain and drop them into another within GUI presented at their respective devices, a bridge can democratize access to cross-chain functionalities, thereby enhancing the overall UX.

The details of one or more implementations are set forth in the accompanying drawings and the description below. Other features and advantages will be apparent from the description and drawings, and from the claims.

### BRIEF DESCRIPTION OF THE DRAWINGS

FIG. 1A is a conceptual diagram of a bridge UI for transferring digital assets between blockchains.

FIG. 1B is a conceptual diagram of a bridge UI for transferring digital assets between subnets.

FIG. 1C is a conceptual diagram of a bridge UI for transferring digital assets between a subnet and a blockchain.

FIG. 2 is a system diagram of one or more components that can be used to perform the disclosed techniques.

FIGS. 3A, 3B, 3C, 3D, 3E, 3F, 3G, 3H, 3I, 3J, and 3K are illustrative examples of a bridge UI for transferring digital assets using the disclosed techniques.

FIG. 4A is a conceptual diagram of receiving input in a bridge UI to transferr digital assets using the disclosed techniques.

FIG. 4B is a conceptual diagram of receiving touch input in a bridge UI to transfer digital assets using the disclosed techniques.

FIG. 4C is a conceptual diagram of receiving audio input in a bridge UI to transfer digital assets using the disclosed techniques.

FIGS. 5A and 5B are a flowchart of a process for using a bridge UI to transfer digital assets between blockchains.

FIG. 6 is a schematic diagram that shows an example of a computing device and a mobile computing device.

In the present disclosure, like-numbered components of various embodiments generally have similar features when those components are of a similar nature and/or serve a similar purpose, unless otherwise noted or otherwise understood by a person skilled in the art.

### DETAILED DESCRIPTION OF ILLUSTRATIVE EMBODIMENTS

This disclosure generally relates to systems, methods, techniques, and technology for enabling cross-chain transactions using drag-and-drop mechanisms in GUIs presented at a user device. The disclosed technology can be implemented to perform cross-chain transactions of one or more digital assets and/or digital data, including but not limited to cryptocurrencies and non-fungible tokens (NFTs). The disclosed technology can be implemented to perform such transactions across various different blockchains, different subnets, and/or a combination thereof.

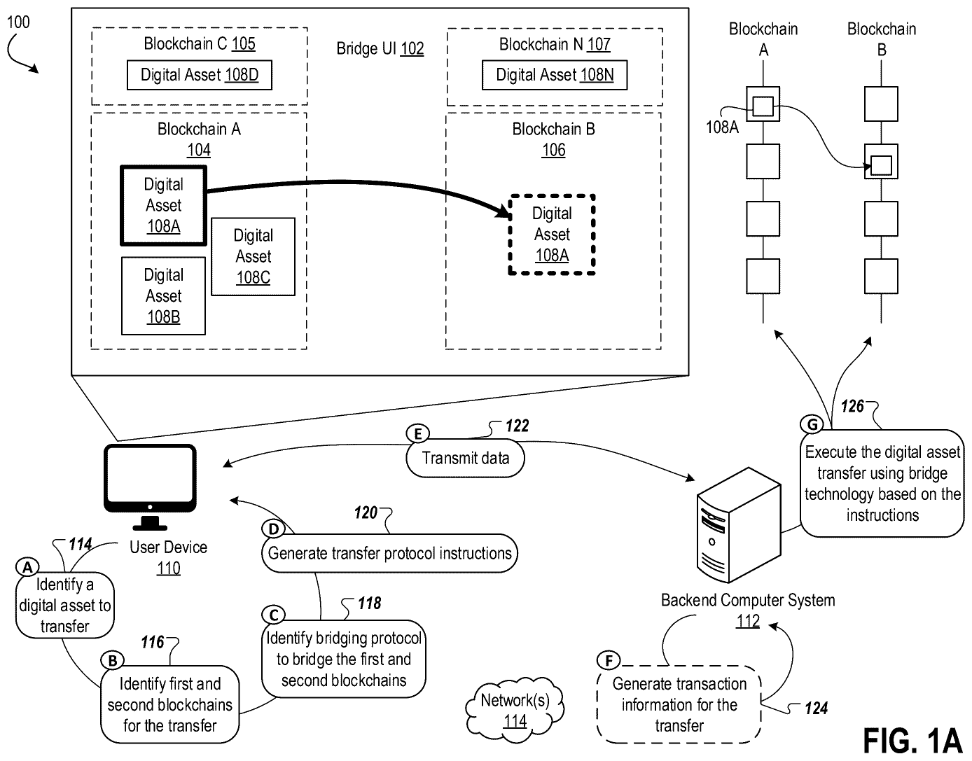

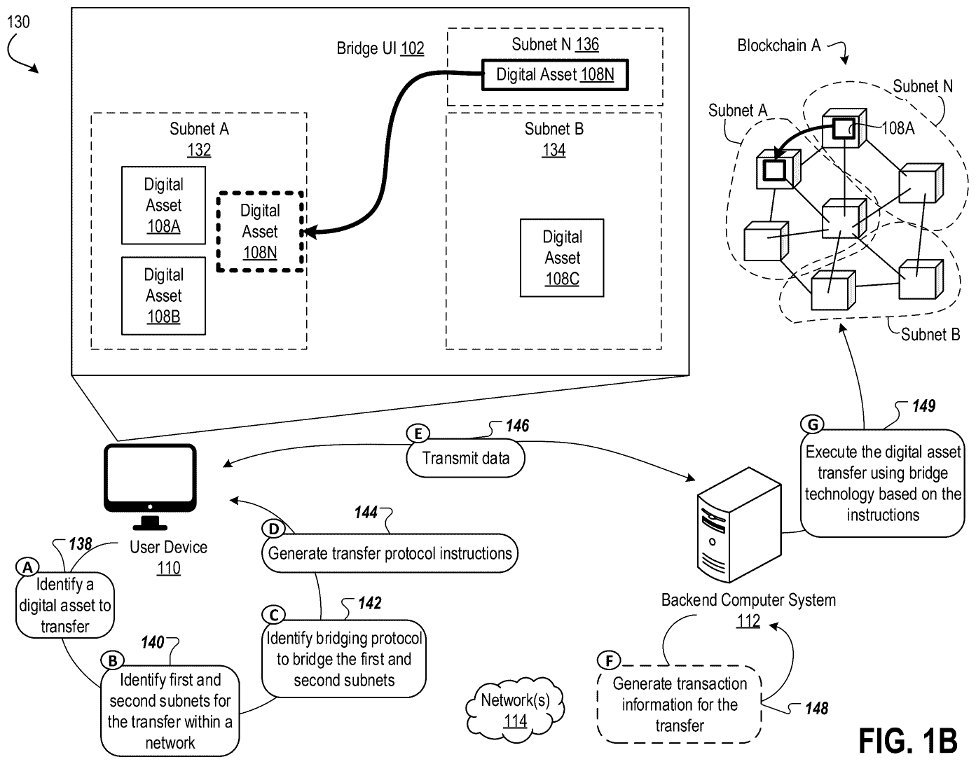

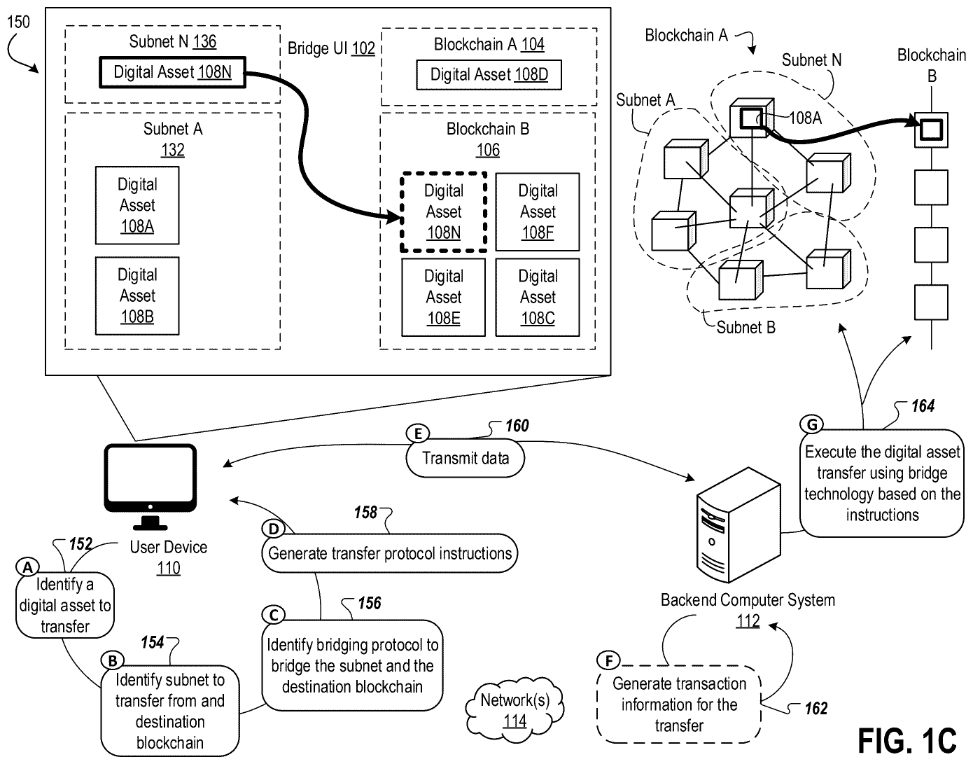

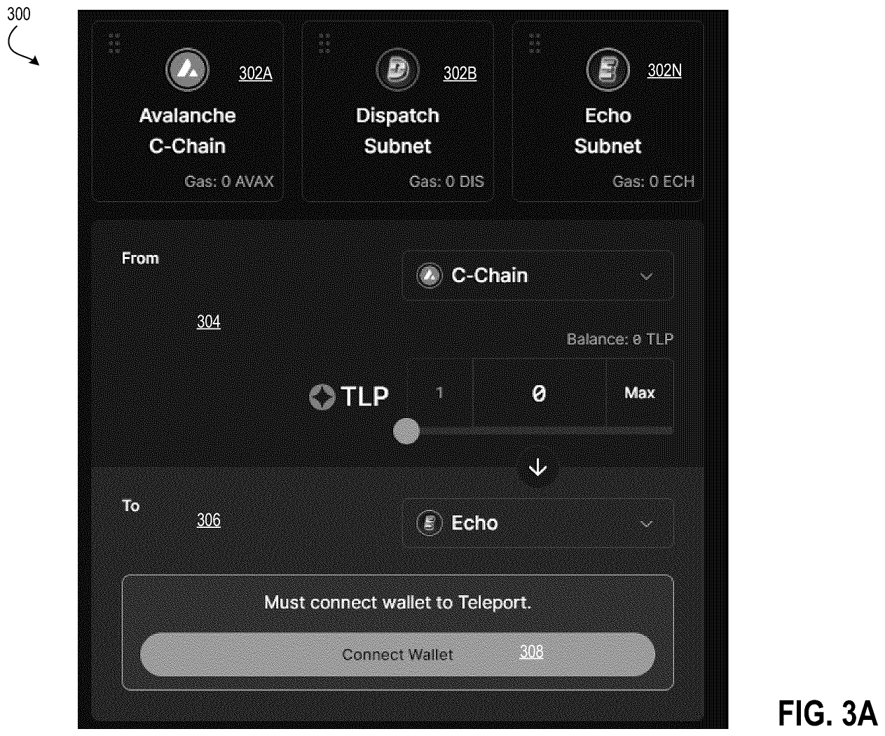

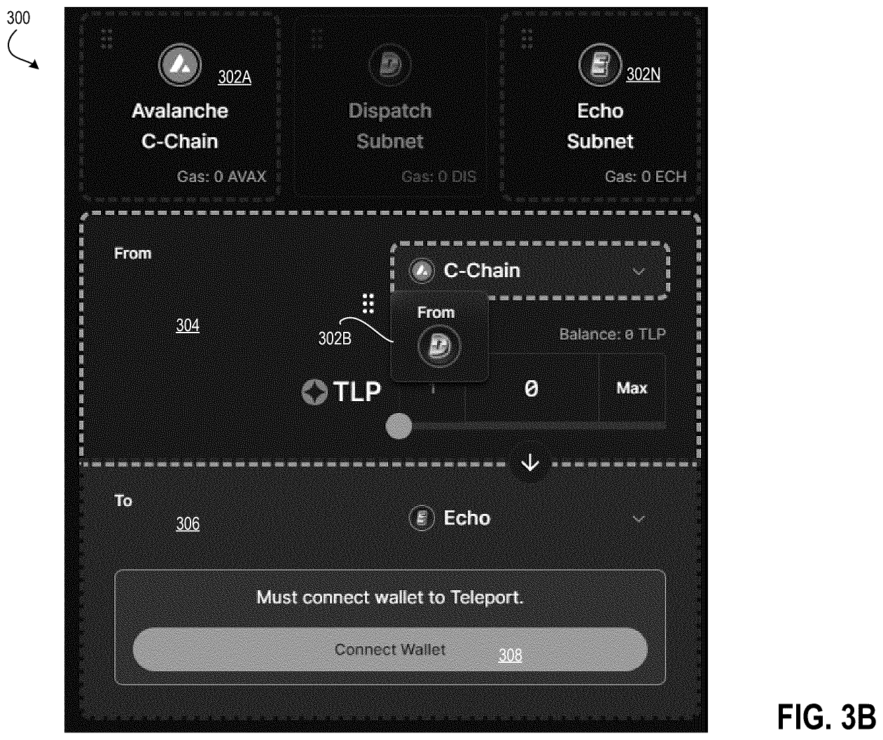

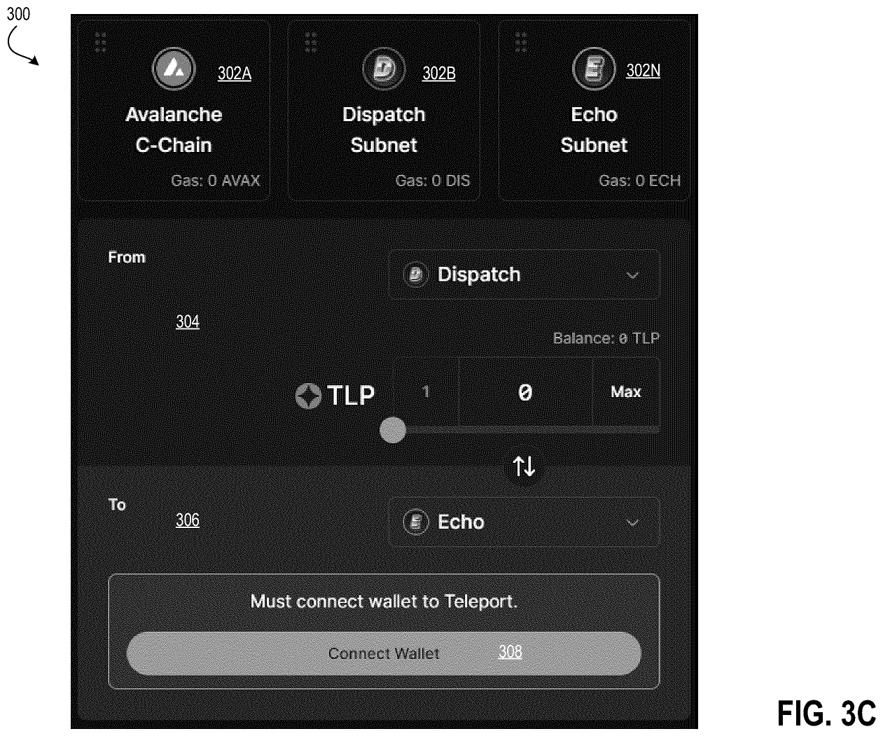

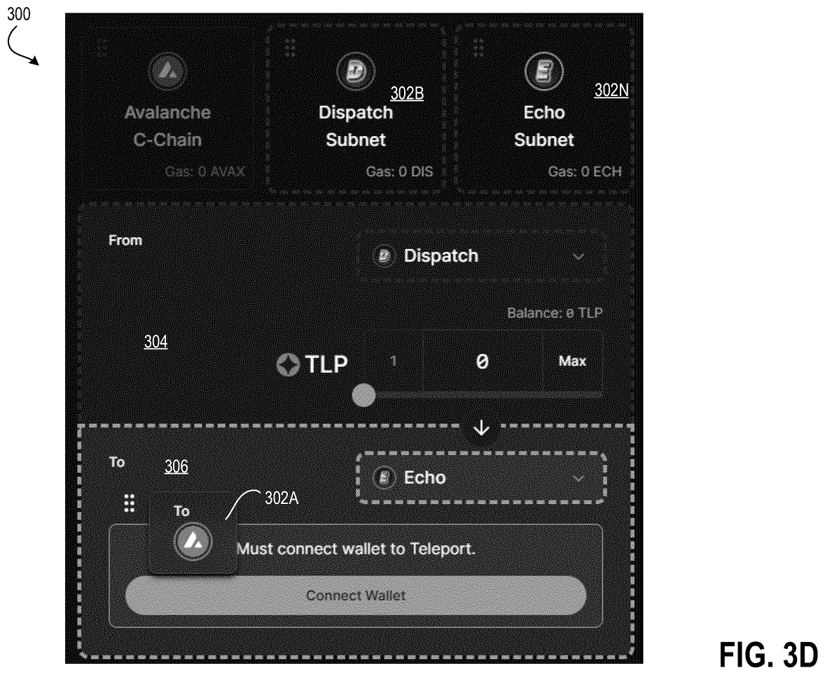

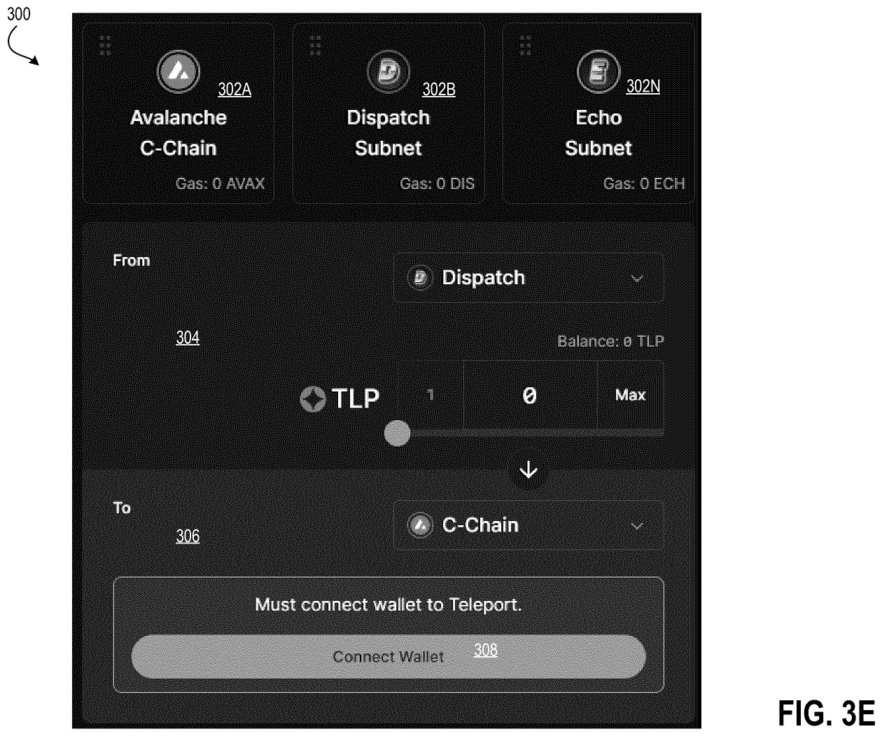

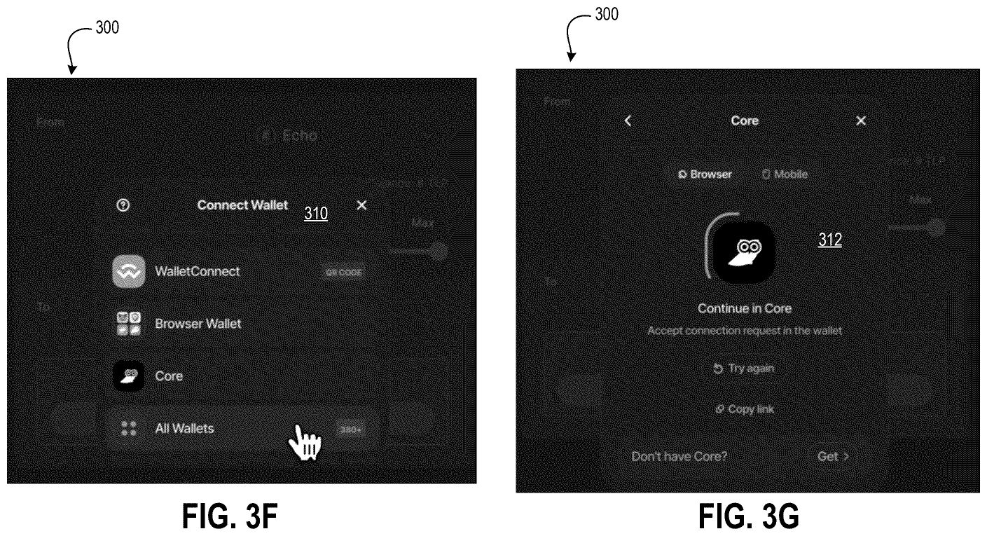

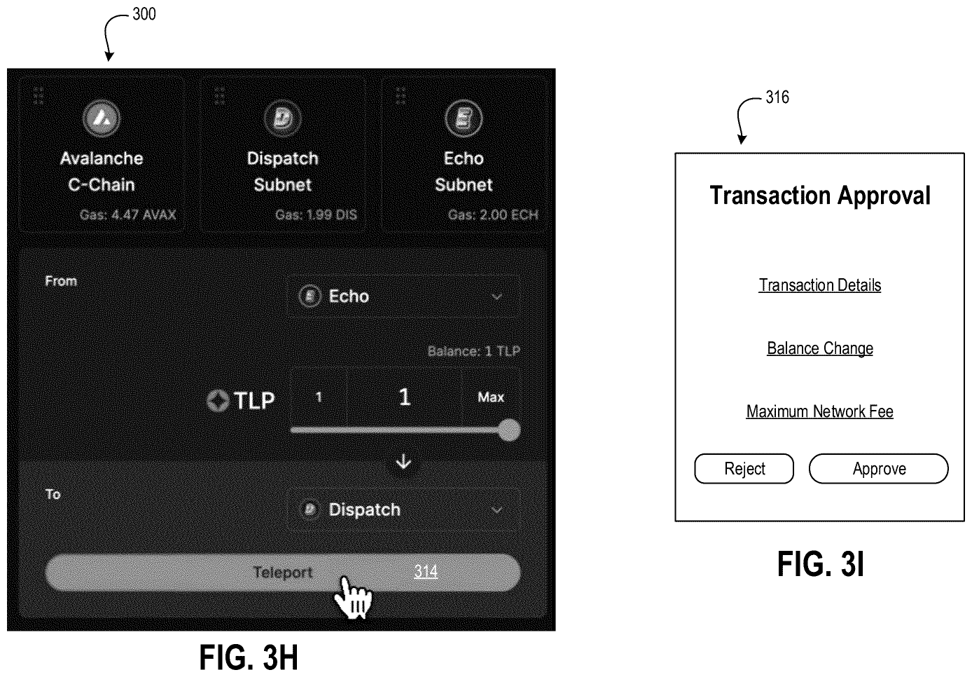

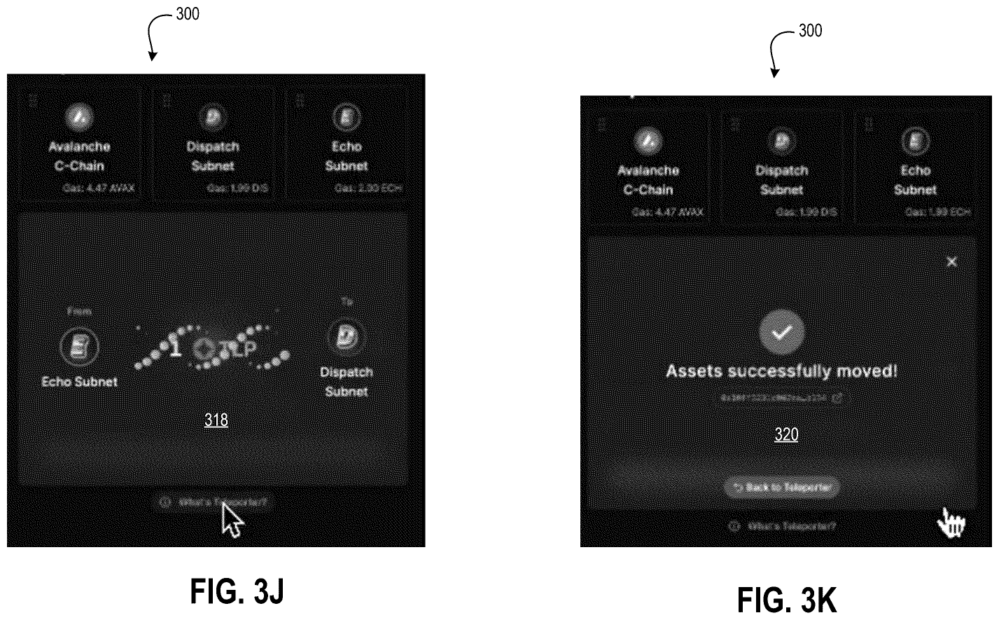

Referring to the figures, FIG. 1A is a conceptual diagram of a system 100 in which a bridge UI 102 for transferring digital assets between blockchains A and B. The bridge UI 102 can be presented at a user device 110. The user device 110 can be any type of computing device of a user seeking to transfer their digital assets, including but not limited to a computer, a laptop, a mobile device, a smartphone, a tablet, and/or a cloud-based computing system. Refer to FIGS. 3A-3K for further discussion about the bridge UI 102. The user device 110 can also communicate (wired, wirelessly) with a backend computer system 112 via network(s) 114. The backend computer system 112 can be a bridging protocol configured to provide bridging technology between the blockchains A and B and one or more other blockchains and/or subnets.

As shown, the bridge UI 102 can include visual representations of blockchain A (104), blockchain B (106), blockchain C (105), and blockchain N (107). Any number of blockchains can be visually represented in the bridge UI 102. In each of the visual representations of the blockchains 104, 105, 106, and 107, the bridge UI 102 can further include visual representations of digital assets 108A-N. In the illustrative example of FIG. 1A, the visual representation of blockchain A (104) includes a visual representation of the digital assets 108A, 108B, and 108C. The visual representation of blockchain B (106), for example, shows that no digital assets are currently located at the blockchain B, until the digital asset 108A is transferred (or requested to be transferred) by the user at the user device 110 and from the blockchain A.

The bridge UI 102 is a user-friendly interface for a bridge provided via the backend computer system 112, which can leverage drag-and-drop functionality. This functionality enables the user at the user device 110 to perform cross-chain transactions by simply dragging a representation of their digital asset (such as the visual representation of the digital asset 108A) from one blockchain (the visual representation of blockchain A (104)) and dropping the digital asset representation onto another blockchain (the visual representation of blockchain B (106)) within the bridge UI 102.

Upon initiating a drag action, the user selects, at the user device 110, the representation of the digital asset 108A from the source chain's wallet (the visual representation of blockchain A (104)). The bridge UI 102 is then automatically updated by the user device 100 to visually represent that the selected digital asset 108A is ‘in transit’ to the destination chain (blockchain B) until the user completes a drop action of the visual representation of the digital asset 108A on the destination chain's icon or area within the UI 102 (such as the visual representation of blockchain B (106)). The user device 110, or the backend computer system 112 in some implementations, can automatically fill in/complete/populate necessary transaction details based on the user input received at the user device 110, including selecting a correct bridge protocol for the involved chains A and B. To enhance understanding and confidence during this transaction process, the UI 102 can display a confirmation window with a summary of the transaction before final submission. This summary can include information such as from/to chains, token amount, and/or an estimated transaction fee. The user can provide input at the user device 110 to confirm the transaction, thereby finalizing the drag-and-drop process. Once the user confirmation is received, the user device 110 can transmit instructions to execute the transfer to the backend computer system 112. Refer to FIGS. 3A-3K for further discussion about the drag-and-drop process described herein.

More specifically, the user device 110 can launch the bridge UI 102 in a GUI display of the user device 110. Sometimes, when the bridge UI 102 is launched, communication can occur between the user device 110 (and sometimes the backend computer system 112) and one or more APIs. Such communication can be established to check one or more wallets associated with the user at the user device 110 and/or whether the user has everything necessary to perform transfers using the bridge UI 102. Such communications can be established to perform one or more other or additional checks, such as whether the user has sufficient gas to perform transfers using the bridge UI 102, whether the user has sufficient amount of digital assets (e.g., tokens) to transfer, whether the user can afford transfers/transactions using the bridge UI 102, etc. In some implementations, if the user device 110 determines that the user is missing one or more items to complete the checks, the user device 110 can present prompts that overlay the bridge UI 102 (or appear in separate windows or within the UI 102 itself) and request the user to complete the missing items. For example, if the user needs more gas for a transfer, the prompt can provide a link to a faucet. As another example, if the user does not have enough tokens at a current time to perform the transfer, then the prompt can include instructions and/or selectable options to mint tokens at the current time. The user device 110 may also communicate with the APIs while the user is providing user input at the user device 110 to perform one or more checks before the transfer is approved and submitted for execution by the backend computer system 112.

Still referring to FIG. 1A, in block A (114), the user device 110 can identify a digital asset to transfer. The user device 110 can identify the digital asset based on translating or processing user input received at the device 110. The user input can include selection (e.g., clicking) of the visual representation of the digital asset 108A in the visual representation of the blockchain A (104) in the bridge UI 102.

The user device 110 can then identify first and second blockchains (e.g., source and destination chains) for the transfer of the digital asset 108A (block B, 116). The first blockchain can be blockchain A and the second blockchain can be blockchain B in this illustrative example. The user device 110 can identify the first and second blockchains based on translating or processing user input received at the device 110. The user input can include dragging the visual representation of the digital asset 108A from the visual representation of the blockchain A (104) across the bridge UI 102 to the visual representation of the blockchain B (106). A dragging action provided at the user device 110 can be translated by the user device 110 as user intent to establish a bridge between the two blockchains.

Next, the user device 110 can identify a bridging protocol to bridge the first and second blockchains in block C (118). The user device 110 can communicate with one or more APIs to identify the appropriate bridging protocol.

The user device 110 can generate transfer protocol instructions in block D (120) and transmit data representing at least the transfer protocol instructions to the backend computing system 112 (block E, 122). The backend computer system 112 can affect the transfer of the digital asset upon receiving the transfer protocol instructions from the user device 110.

Optionally, the backend computer system 112 may generate transaction information for the transfer (block F, 124). Sometimes, block F (124) can be performed while the user device 110 is performing one or more of blocks A-D (114-120). For example, the backend computer system 112 can generate the transaction information once the user device identifies the chains for the transfer in block B (116), provide the transaction information to the user device 110 to present in the bridge UI 102, and upon receiving user input indicating confirmation of the presented transaction information, any one or more of the blocks C (118), D (120), and/or G (126) can be performed.

The backend computer system 112 can also execute the digital asset transfer using bridge technology and based on the instructions received from the user device 110 (block G, 126). Executing the transfer can include communicating, via the bridge technology, with both the blockchains A and B to cause the transfer of the digital asset 108A from blockchain A to blockchain B. In brief, when bridging, the backend computer system 112 can cause the digital asset 108A to be locked on the blockchain A and minted on the blockchain B. Once the backend computer system 112 receives validation that the locking and/or minting actions have been completed, the backend computer system 112 can cause for the locked asset on the blockchain A to be burned/torched. Refer to U.S. Pat. No. 11,836,714, entitled “Secure and trustworthy bridge for transferring assets across networks with different data architecture,” having an earliest priority date of Jul. 7, 2021 and a filing date of Apr. 22, 2022, which is incorporated herein in its entirety, for further discussion about bridging operations performed by the backend computer system 112.

In some implementations, the backend computer system 112 may not perform operations until the bridge transfer/transaction is issued by the user at the user device 110 (e.g., receiving user input indicating that the user confirmed the transfer). Sometimes, once the visual representation of the digital asset 108A is dropped onto the visual representation of the blockchain B (106), the transfer of the digital asset can be automatically initiated and the bridge transaction can be automatically performed by the backend computer system 112.

The disclosed technology can be implemented in multiple different scenarios and/or use cases. As another illustrative example, the disclosed technology can be implemented to transfer digital asses (such as tokens) between a list of addresses between blockchains and/or subnets. For example, the disclosed technology can be used to transfer a particular token from user A's wallet address to user B's wallet address. In the example of the bridge UI 102, the user at the user device 110 can present a list of addresses that the user (e.g., user A) controls in one designated region of the UI 102 and a list of addresses that the other user (e.g., user B) controls in a second designated region of the UI 102. The lists of addresses can be on same subnets, different subnets, different blockchains, or any combination thereof.

FIG. 1B is a conceptual diagram of a system 130 in which the bridge UI 102 is used for transferring digital assets between subnets. In the example of FIG. 1B, the bridge UI 102 presents visual representations of subnet A (132), subnet B (134), and subnet N (136). The bridge UI 102 also presents the visual representations of the digital assets 108A-N with the subnets to which they belong/are located. Here, the subnets A, B, and N can be part of the same blockchain, blockchain A, and the disclosed techniques can be used to transfer digital assets between subnets on the same blockchain. In some implementations, one or more of the subnets can be part of different blockchains and/or different networks, and the disclosed techniques can be used to transfer digital assets between subnets on different blockchains.

In block A (138), the user device 110 can identify a digital asset to transfer. Refer to block A (114) in FIG. 1A for further discussion.

The user device 110 can identify first and second subnets for the transfer within a network (or different networks) (block B, 140). Refer to block B (116) in FIG. 1A for further discussion.

The user device 110 can identify a bridging protocol to bridge the first and second subnets in block C (142). Refer to block C (118) in FIG. 1A for further discussion.

Then, the user device 110 can generate transfer protocol instructions in block D (144). Refer to block D (120) in FIG. 1A for further discussion.

The user device 110 can transmit data to the backend computer system 112, which can include the transfer protocol instructions (block E, 146). Refer to block E (122) in FIG. 1A for further discussion.

The backend computer system 112 can optionally generate transaction information for the transfer (block F, 148). Refer to block F (124) in FIG. 1A for further discussion.

The backend computer system 112 can also execute the digital asset transfer using bridge technology and based on the transmitted instructions (and the transaction information) (block G, 149). Refer to block G (126) in FIG. 1A for further discussion.

FIG. 1C is a conceptual diagram of a system 150 in which the bridge UI 102 is used for transferring digital assets between a subnet and a blockchain. In the example of FIG. 1C, the bridge UI 102 presents visual representations of at least the subnet A (132), the subnet N (136), the blockchain A (104), and the blockchain B (106). The bridge UI 102 also presents the visual representations of the digital assets 108A-N with the subnets and/or blockchains to which they belong/are located. Here, the subnets A and N can be part of the same blockchain or different blockchains/networks. Here, the disclosed techniques can be used to transfer digital assets from subnets to blockchains. The disclosed techniques can also be used to transfer digital assets from blockchains to subnets.

In block A (152), the user device 110 can identify a digital asset to transfer. Refer to block A (114) in FIG. 1A for further discussion.

The user device 110 can identify a subnet to transfer from and a destination blockchain (block B, 154). Based on user input (drag-and-drop functionality described herein), the user device 110 can identify the subnet N as a source subnet and the blockchain B as the destination chain. In some implementations, the disclosed techniques can also be used to identify a source chain and a destination subnet. Refer to block B (116) in FIG. 1A for further discussion.

The user device 110 can identify a bridging protocol to bridge the subnet and the destination blockchain in block C (156). Refer to block C (118) in FIG. 1A for further discussion.

Then, the user device 110 can generate transfer protocol instructions in block D (158). Refer to block D (120) in FIG. 1A for further discussion.

The user device 110 can transmit data to the backend computer system 112, which can include the transfer protocol instructions (block E, 160). Refer to block E (122) in FIG. 1A for further discussion.

The backend computer system 112 can optionally generate transaction information for the transfer (block F, 162). Refer to block F (124) in FIG. 1A for further discussion.

The backend computer system 112 can also execute the digital asset transfer using bridge technology and based on the transmitted instructions (and the transaction information) (block G, 164). Refer to block G (126) in FIG. 1A for further discussion.

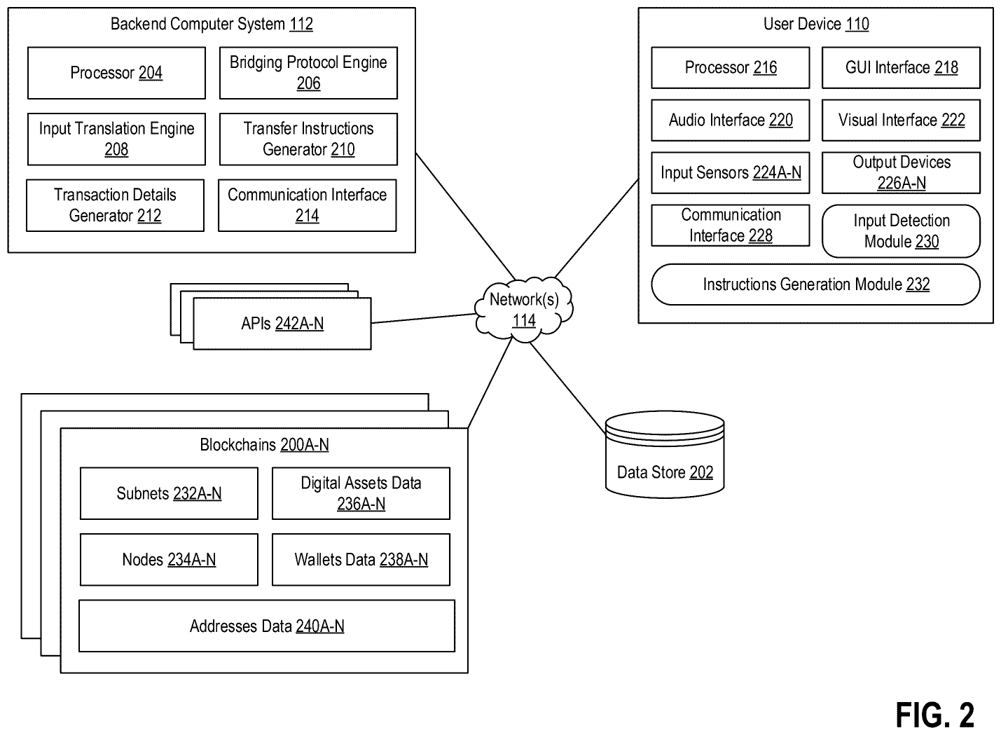

FIG. 2 is a system diagram of one or more components that can be used to perform the disclosed techniques. The user device 110, the backend computer system 112, blockchains 200A-N, a data store 202, and/or APIs 242A-N can communicate with each other over the network(s) 114.

The user device 110 can include a processor 216, a GUI interface 218, an audio interface 220, a visual interface 222, input sensors 224A-N, output devices 226A-N, a communication interface 228, an input detection module 230, and/or an instructions generation module 232. In brief, the processor 216 can be configured to store and execute instructions for performing operations described herein. The communication interface 228 can be configured to provide communication between components of the user device 110 and the other system components described herein.

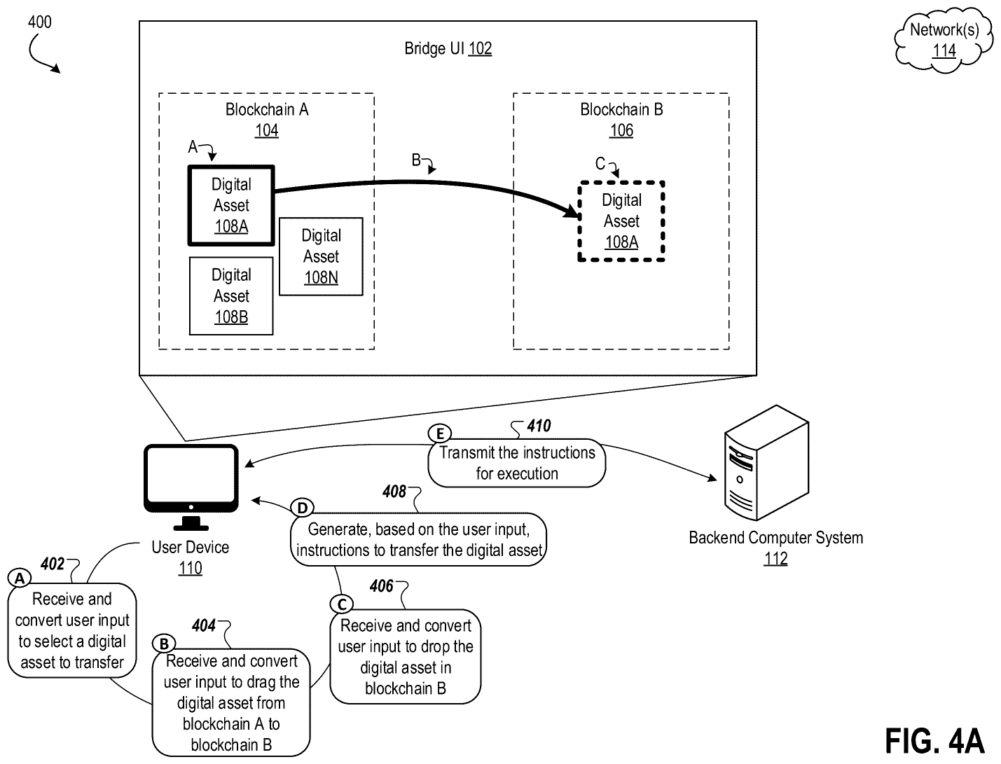

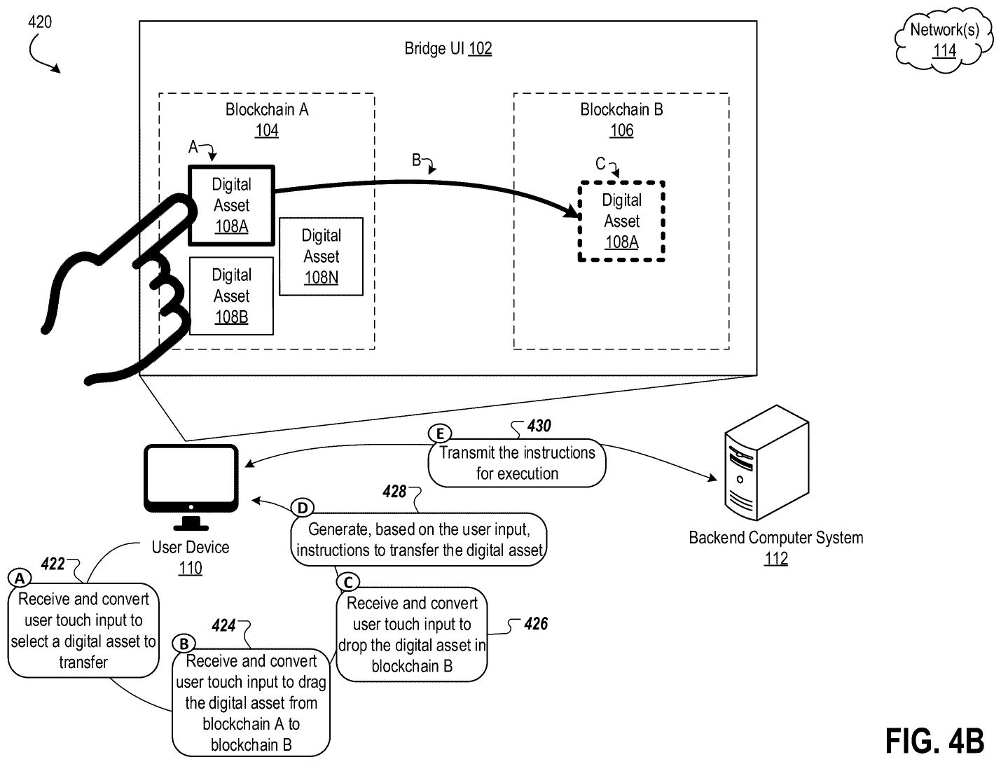

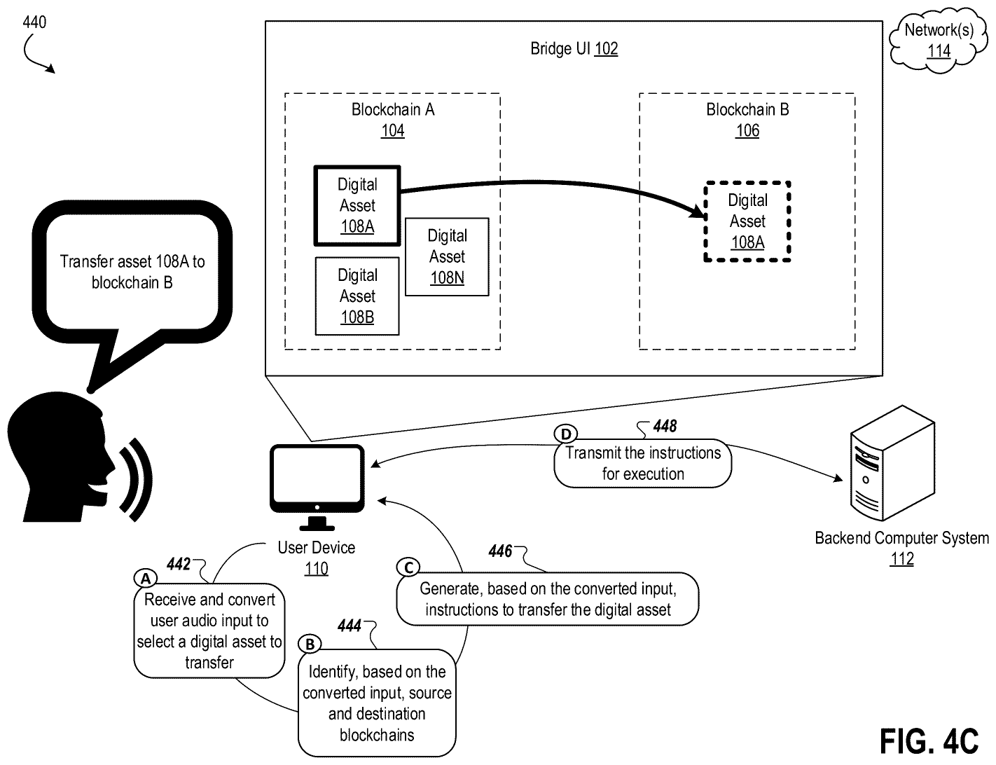

The GUI interface 218 can be configured to present any of the UIs described herein. Refer to FIGS. 3A-3K for further discussion about the UIs. The GUI interface 218 can, for example, visually present a UI at one of the output devices 226A-N(e.g., a display screen) of the user device 110. The GUI interface 218 can also receive user input, via one or more of the input sensors 224A-N, based on information presented in the UIs at the GUI interface 28. The user input can include touch, clicks, taps, or other feedback with the user device 110. The visual interface 222, similar to the GUI interface 218, can be configured to visually present any of the UIs described herein. Refer to FIGS. 4A and 4B for further discussion.

The audio interface 220 can be configured to present and/or receive information that otherwise may be visually presented in the UIs described herein. For example, the audio interface 220 can be configured to receive audio commands or inputs from a user, via one of the input sensors 224A-N, which can then be translated, by the input detection module 230, to operations, such as transferring a digital asset from one blockchain to another, as described herein. Refer to at least FIG. 4C for further discussion.

The input sensors 224A-N can include any type of sensor that can be configured to capture signals, comments, and/or other forms of user input. For example, the input sensors 224A-N can include a keyboard, mouse, microphone, haptic feedback system, and/or touchscreen display.

The output devices 226A-N can include any type of devices that can be configured to output information, such as the UIs described herein. The output devices 226A-N can include a display, a screen, a touchscreen, speakers, and/or a haptic feedback system.

The input detection module 230 can be a software module configured to hook into or otherwise communicate with the GUI interface 218, the audio interface 220, and/or the visual interface 222 to receive user input provided therein. The module 230 can further process, translate, and/or convert the user input indicating user intent into actions with regards to a transfer of digital assets. The translation of user input into actions can further be visually or audibly presented at the respective interface 218, 220, and/or 222. For example, the module 230 can generate instructions for execution by the respective interface 218, 220, and/or 222 to visually or audibly present the actions therein (e.g., dragging and dropping a visual representation of a digital asset from a visual representation of a blockchain to a visual representation of another blockchain).

The instructions generation module 232 can receive output from the input detection module 230 and determine information about a transfer of the digital asset to be performed. For example, the module 232 can perform at least blocks A-D (114-120) in FIG. 1A.

The backend computer system 112 can include a processor 204, a bridging protocol engine 206, an input translation engine 208, a transfer instructions generator 210, a transaction details generator 212, and a communication interface 214. In some implementations, the backend computer system 112 may include less than all of the components described herein. In brief, the processor 204 can be configured to maintain and execute instructions to perform the disclosed techniques. The communication interface 214 can be configured to provide communication via the network(s) 114 between the components of the backend computer system 112 and other system components described herein.

The bridging protocol engine 206 can be configured to execute bridging technology, bridging protocols, and transfer instructions to affect transfers and other transactions across blockchains, as described throughout this disclosure.

The input translation engine 208 can be configured to process any user input received at the user device 110 to determine user intent and subsequent actions to be performed for a specific user-initiated transfer or other transaction. The engine 208 can be similar to the input detection module 230 described in reference to the user device 110.

The transfer instructions generator 210 can be configured to generate instructions for executing the user-initiated transfer or other transaction according to an appropriate bridging protocol for the user-initiated transfer or other transaction. The generator 210 can be similar to the instructions generation module 232 described in reference to the user device 110.

The transaction details generator 212 can be configured to determine one or more details about the user-initiated transfer or other transaction. For example, based on user input received at the user device 110, the generator 212 can automatically populate information associated with the user-initiated transfer, such as wallet addresses and/or amounts of a particular token to be transferred. In some implementations, such operations can be performed locally at the user device 110, such as by the instruction generation module 232 and/or the input detection module 230. The generator 212 can automatically populate the transaction details by polling the user device 110 for user input, the APIs 242A-N, the data store 202, and/or the blockchains 200A-N. The transaction details can then be transmitted to the user device 110 for presentation in one of the interfaces 218, 220, and/or 222.

The APIs 242A-N can be accessed by the user device 110 and/or the backend computer system 112 as the disclosed techniques are being performed. As described in reference to FIG. 1A, the user device 110 can communicate with the APIs 242A-N to access information about the user's wallet(s) and/or digital assets (which can be stored in the data store 202 and/or at the blockchains 200A-N). The user device 110 can then utilize that information to perform checks, such as determining whether the user has sufficient gas and/or digital assets to perform the user-initiated transfer. Likewise, the backend computer system 112 can communicate with the APIs 242A-N to perform similar checks, information retrievals, and/or operations to affect a successful transfer of digital assets as requested by the user at the user device 110.

The blockchains 200A-N can each include one or more subnets 232A-N, nodes 234A-N, digital assets data 236A-N, wallets data 238A-N, and/or addresses data 240A-N. The blockchains 200A-N can include any known or existing chains, networks, and/or networks of chains.

The data store 202 can be any type of data repository that can be configured to maintain information used for performing the disclosed techniques. In some implementations, the data store 202 can be part of the backend computer system 112. The data store 202 can maintain accessible information such as digital assets data, wallets data, addresses data, user data, and/or bridging protocol information.

FIGS. 3A, 3B, 3C, 3D, 3E, 3F, 3G, 3H, 3I, 3J, and 3K are illustrative examples of a bridge UI 300 (e.g., GUI) for transferring digital assets using the disclosed techniques. The GUI 300 depicted herein is similar to or the same as the bridge UI 102 depicted and described at least in FIGS. 1A, 1B, and 1C. The GUI 300 and the bridge UI 102 can have the same or similar functionality. In the examples of FIGS. 3A-3K, a user can use drag-and-drop functionality to select a source chain or a source subnet and a destination chain or a destination subnet. In other words, the user can select, drag, and drop a visual representation of a chain or subnet to a source chain field in the GUI 300 and select, drag, and drop a visual representation of another chain or another subnet to a destination chain field in the GUI 300. Once the user confirms their actions and transaction details associated with such user-initiated transfer of assets, a transfer of the digital asset can actually be performed (by the backend computer system 112 described herein) using bridging technology.

FIG. 3A illustrates the GUI 300 having visual representations 302A, 302B, and 302N of one or more blockchains and/or subnets. The GUI 300 further includes a region 304 for information regarding a source chain (or subnet) and initiation of an asset transfer (the source region 304). The GUI 300 includes a region for destination information regarding a destination chain (or subnet) (the destination region 306). The destination region 306 may also include a selectable option 308 (e.g., a button) for connecting a wallet to the user-initiated transfer in the GUI 300.

Both the source region 304 and the destination region 306 can include selectable options (e.g., drop down menus) for the user to select respective source and destination chains (or subnets). As described herein, the user can also select one of the visual representations 302A-N of the chains and/or subnets, then drag that selected visual representation into either the source region 304 or the destination 306. By dragging and dropping the selected visual representation into either region 304 or 306, the user is indicating what they desire to do for their asset transfer.

The source region 304 can also include selectable features (e.g., a toggle bar) to adjust a quantity or amount of a particular asset to be transferred from the source chain/subnet to the destination chain/subnet. The user can adjust that feature, such as clicking and dragging along a toggle or slide bar, to indicate the total amount of the asset to transfer. In some implementations, the source region 304 can also include a selectable feature (e.g., drop down menu, visual depictions) for identifying which of the user's assets to be transferred from the source chain/subnet to the destination chain/subnet.

FIG. 3B illustrates the GUI 300 when the user has selected the visual representation 302B of a subnet and dragged the selected visual representation 302B to the source region 304 of the GUI 300. As the selected visual representation 302B is hovered over the source region 304, the source region 304 can be highlighted, or otherwise emphasized with some type of indicia (e.g., change in color, change in text styling/font/color/size) to easily and visually illustrate the user's actions to the user. As a result, the user can easily understand and visualize that they have identified the subnet associated with the selected visual representation 302B as the source subnet in their transfer of assets.

FIG. 3C illustrates the GUI 300 once the user has dropped the selected visual representation 302B in any portion of the source region 304. The source region 304 is automatically updated to present the subnet associated with the selected visual representation 302B. As a result of the user dropping the selected visual representation 302B (or an inaction of the user at their device), the highlighting that was shown around the source region 304 in the GUI 300 of FIG. 3B is no longer visible.

FIG. 3D illustrates the GUI 300 as the user selects the visual representation 302A of a blockchain, drags the selected visual representation 302A to hover over the destination region 306 (which now appears highlighted, similarly to the source region 304 as described in reference to FIG. 3B), and drops or releases the selected visual representation 302A in any portion of the destination region 306. Here, the user is using the drag-and-drop functionality to automatically change the destination chain in the digital asset transfer that they have initiated.

FIG. 3E illustrates the GUI 300 once the user has dropped the selected visual representation 302A into any portion of the destination region 306. The destination region 306 has been automatically updated to present the blockchain associated with the selected visual representation 302A. As a result of the user dropping the selected visual representation 302A (or an inaction of the user at their device), the highlighting that was shown around the destination region 306 in the GUI 300 of FIG. 3D is no longer visible.

FIG. 3F illustrates a modal window 310 (e.g., pop out window) that appears as overlaying at least a portion of the GUI 300 described herein when the user selects the option 308 (refer to at least FIG. 3E) to connect their wallet. As shown in FIG. 3F, the window 310 can present one or more wallets that can be connected through the GUI 300 to affect the transfer of digital assets from the source chain/subnet to the destination chain/subnet. The window 310 can present a selectable option for each of the user's available wallets. The window 310 can also include one or more selectable options (e.g., buttons) to view or browse other wallets, including but not limited to wallets associated with the user and other types of wallets (e.g., wallets that the user may not already have but may desire to create).

FIG. 3G illustrates a modal window 312, which can appear as overlaying at least a portion of the GUI 300 described herein when the user selects one of the wallets presented in the window 310 of FIG. 3F. In some implementations, the window 312 can be the same as the window 310. For example, in response to the user input to select one of the wallets, the window 310 can be updated from presenting information about the user's wallets to presenting information about connected to the user-selected wallet.

The window 312 can present information such as a visual icon or indication of progress in connecting to the user-selected wallet. The window 312 can present instructions for completing the connection, such as instructing the user to accept a connection request in the user-selected wallet. The user can also select options to toggle between browser and mobile access to their wallet. Moreover, the window 312 can include selectable options for establishing a new connection with the user-selected wallet (or a server or platform that hosts the wallet), for copying a link to accept the connection request (which, when inputted into the user's device web browser can open a webpage that allows the user to accept the request), and/or for downloading software or a platform to access the user-selected wallet. Various other information can also be presented in the window 312.

FIG. 3H illustrates the GUI 300 once the user-selected wallet has been successfully connected through the GUI 300, and thus available for performing the transfer of the digital assets between the source and destination chains/subnets. As shown in FIG. 3H, the selectable option 308 to connect a wallet has now been replaced with a selectable option 314 to perform the transfer of the digital assets. Sometimes, the options 308 and 314 can be the same option, however once the wallet is connected, the option can be updated to include text indicating that selection of the option will cause the transfer to be initiated.

The user can connect their wallet at any point through the GUI 300. Sometimes, the user may connect their wallet before selecting the source and destination chains/subnets. Regardless, once the user connects their wallet, the option 314 becomes visible for the user to transfer the digital assets. In some implementations, the user's wallet can be connected at a time of loading or launching the GUI 300 at their device. As a result, once the GUI 300 appears, the user may only see the option 314 and no the option 308 to connect a wallet. In yet some implementations, both the options 308 and 314 can be visible at the same time in the GUI 300. The option 314 may not be selectable, in some instances, until the user completes updating the source and destination chains/subnets and the digital asset transfer details/amount.

FIG. 3I illustrates a modal window 316, which can be presented as overlaying at least a portion of the GUI 300 described herein. The modal window 316 can be presented in response to the user selecting the option 314 to initiate the transfer. The window 316 can present information for the user to review, approve, and confirm before allowing the transfer to occur. Once the user approves the transaction/transfer information presented in the window 316, the user's device can transmit transfer and bridge protocol instructions to the backend computer system described herein to execute the transfer between the source and destination chains/subnets (refer to at least FIG. 1A for further discussion).

The window 316 can present information such as transaction details, a balance change to be expected as a result of the transfer, and any potential network fees. The transaction details can include, but are not limited to, wallet IDs, user IDs, transaction IDs, network information, etc. The network fees can include one or more selectable options for increasing a speed at which the transfer occurs. Each of the selectable options for speed of transmission can also include information such as costs associated with selecting that option and/or a speed at which the transmission will occur/be increased. The window 316 can also include one or more selectable options (e.g., buttons) such as an option to reject the transaction/transfer and an option to approve the transaction/transfer.

FIG. 3J illustrates the GUI 300 as the transfer is being performed. The GUI 300 is updated automatically to include a graphical portion 318 (where the source region 304 and the destination region 306 used to be presented in the GUI 300). The graphical portion 318 can include graphics indicating that the transfer is occurring between the user-selected source and destination chains/subnets. The GUI 300 of FIG. 3J can be presented in response to the user selecting the option to approve the transaction/transfer in the modal window 316 depicted and described in FIG. 3I. In some implementations, the GUI 300 of FIG. 3J can be presented in response to the user selecting the option 314 to initiate the transfer in FIG. 3H. The GUI 300 of FIG. 3J can then be presented at the user device and the modal window 316 of FIG. 3I can be presented as partially overlaying the GUI 300 of FIG. 3J.

FIG. 3K illustrates the GUI 300 once the transfer has been completed. The GUI 300 is updated automatically (in response to receiving a notification from the backend computer system that the transfer has been successfully completed) to include a graphical portion 320. In some implementations, the graphical portion 320 can be the same as the graphical portion 318. In other words, the graphical portion 318 shown in FIG. 3J can be automatically updated to include information shown in the graphical portion 320 of FIG. 3K. The graphical portion 320 can include graphics and information indicating that the transfer has been successfully completed. In some implementations, the graphical portion 320 can include a selectable option to return to the GUI 300 shown in one or more of FIGS. 3A-3E and/or 3H.

FIG. 4A is a conceptual diagram of a system 400 for receiving input in the bridge UI 102 to transfer digital assets using the disclosed techniques. One or more components in the system 400 are the same as or similar to other components described herein, such as in reference to FIG. 1A. In the system 400, the user device 110 launches the bridge UI 102 in its respective GUI display. The user can provide input using one or more input devices, such as a mouse or keyboard, to select the visual representation of the digital asset 108A, drag the selected visual representation of the digital asset 108A across the bridge UI 102, and drop or release the selected visual representation of the digital asset 108 in the region 106 associated with the blockchain B.

Accordingly, the user device 110 can receive and convert user input to select the digital asset 108A to initiate a transfer (block A, 402). The user device 110 can receive and convert additional user input to drag the digital asset 108A from the blockchain A to the blockchain B (block B, 404). Next, the user device 110 can receive and convert user input to drop the digital asset 108A in blockchain B (block C, 406). In performing both blocks B and C (404 and 406, respectively), the user device 110 can identify the user's intent to transfer the digital asset 108A from the blockchain A (the source) to the blockchain B (the destination). In block D, the user device 110 can generate, based on the user input, instructions to transfer the digital asset 108A. The user device 110 can transmit the instructions to the backend computer system 112 for execution (block E, 410). The backend computer system 112 can then execute the transfer as described in reference to at least FIG. 1A.

Sometimes, as described in reference to at least FIGS. 3A-3K, the user device 110 can present information to the user to verify or approve of the transfer before the user device 110 transmits the instructions to perform the transfer by the backend computer system 112. The operations described herein can be performed at the user device 110 by the GUI interface 218, the visual interface 222, the input detection module 226A-N, and/or the instructions generation module 232 described in reference to FIG. 2.

FIG. 4B is a conceptual diagram of a system 420 for receiving touch input in the bridge UI 102 to transfer digital assets using the disclosed techniques. The system 420 is similar to the system 400 described in reference to FIG. 4A. In the system 420 of FIG. 4B, the user device 110 can receive an convert gesture-based controls, such as touch inputs provided by the user on a touchscreen display or using a haptic feedback system. As a result, such gesture-based controls on touch-enabled devices can provide for an intuitive user experience with the bridge UI 102.

In block A (422), the user device 110 can receive and convert user touch input to select the digital asset 108A to transfer. The user device 110 can then receive and convert user touch input to drag the digital asset 108A from the blockchain A to the blockchain B (block B, 424). In block C (426), the user device 110 can receive and convert additional user touch input (or inaction) to drop the digital asset 108A in the blockchain B. Accordingly, the user device 110 can then generate, based on the user input, instructions to transfer the digital asset (block D, 428). The user device 110 can then transmit the instructions for execution to the backend computer system 112 (block E, 430). Refer to FIG. 4A for further discussion about the operations performed by the user device 110. The operations described herein can be performed at the user device 110 by the GUI interface 218, the visual interface 218, the input detection module 226A-N, and/or the instructions generation module 232 described in reference to FIG. 2.

FIG. 4C is a conceptual diagram of a system 440 for receiving audio input in the bridge UI 102 to transfer digital assets using the disclosed techniques. The system 440 is similar to the system 400 described in reference to FIG. 4A. In the system 440 of FIG. 4C, the user device 110 can receive voice or audio commands from the user to initiate and complete the drag-and-drop functionality described herein. As a result, the disclosed techniques can also accommodate users with disabilities or users who prefer providing voice or audio input instead of touch, haptic feedback, or other controls with components of the user device 110.

In block A (442), the user device 110 can receive and convert user audio input to select the digital asset 108A to transfer. Converting the user input can include performing language processing techniques to listen for specific types of commands, words, and/or phrases that can indicate the user's intent to perform a transfer of their digital assets. For example, the user device 110 can implement one or more rule sets, algorithms, and/or machine learning models to process the audio input and identify the commands, words, and/or phrases. The user device 110 can also access one or more libraries and/or dictionaries (via APIs described herein) with the types of commands, words, and/or phrases that are indicative of the user's intent to perform a transfer of their digital assets. Those commands, words, and/or phrases may include but are not limited to generic terms related to transferring and/or transacting digital assets and other types of tokens or digital data, different names or known blockchains, subnets, and/or other networks, different names or known types of digital assets, tokens, data, wallets, etc., and other terminology associated with cross-chain transactions.

The user device 110 can then identify, based on the converted input, the source and destination blockchains (block B, 444). In block C (446), the user device 110 can generate, based on the converted input, instructions to transfer the digital asset. The user device 110 can then transmit the instructions for execution to the backend computer system 112 (block D, 448). Refer to FIG. 4A for further discussion about the operations performed by the user device 110. The operations described herein can be performed at the user device 110 by the GUI interface 218, the audio interface 220, the input detection module 226A-N, and/or the instructions generation module 232 described in reference to FIG. 2.

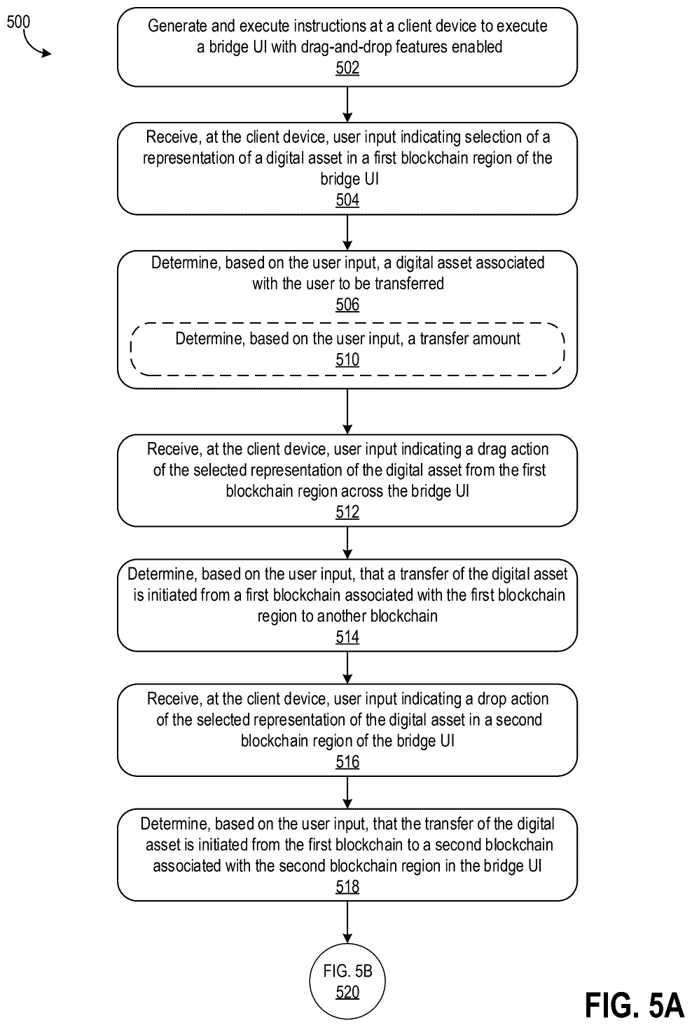

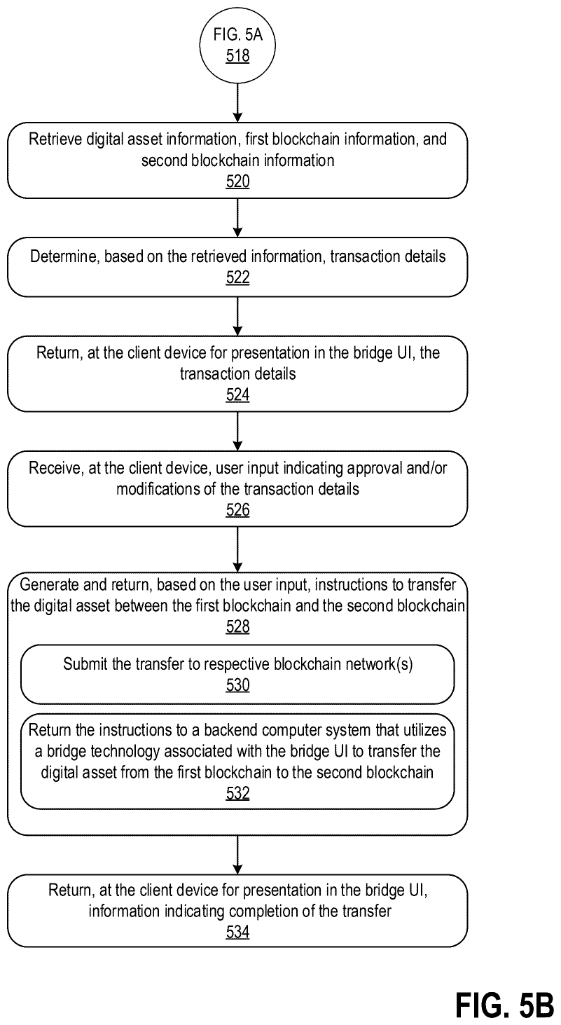

FIGS. 5A and 5B are a flowchart of a process 500 for using a bridge UI to transfer digital assets between blockchains. The process 500 is described from the perspective of dragging and dropping visual representations of digital assets into regions in the bridge UI that are designated for first and second (source and destination) blockchains, as shown in at least FIG. 1A. The process 500 can also be performed for dragging and dropping the visual representations of digital assets into regions in the bridge UI that are designated for subnets and/or a combination of subnets and blockchains or other types of networks (refer to FIGS. 1B and 1C). In yet some implementations, the process 500 can be performed for dragging and dropping visual representations of blockchains and/or subnets into regions in the bridge UI that are designated for source and destination chains/subnets, as shown and described in further detail in reference to FIGS. 3A-3K.

The process 500 can be performed by the user device 110. The process 500 can also be performed by one or more other client devices, computing systems, devices, computers, networks, cloud-based systems, and/or cloud-based services. In some implementations, one or more operations in the process 500 can be performed by the backend computer system 112 described herein. For illustrative purposes, the process 500 is described from the perspective of a client device.

Referring to the process 500 in both FIGS. 5A and 5B, the client device can generate and execute instructions to execute a bridge UI with drag-and-drop features enabled (block 502). Once the bridge UI is launched with the enabled features, the user can begin a transaction process. Refer to at least FIG. 1A and FIGS. 3A-3K for further discussion about the bridge UI.

The client device can receive, at the client device, user input indicating selection of a representation of a digital asset in a first blockchain region of the bridge UI (block 504). Selecting and initiating a drag action on the visual representation of the digital asset can indicate the user's desire to transfer that particular digital asset.

Accordingly, the client device can determine, based on the user input, a digital asset associated with the user to be transferred in block 506. Optionally, the client device may determine, based on the user input, a transfer amount (block 510). The transfer amount may be provided as user input. In some implementations, if the user's wallet contains a limited amount of the digital asset, the client device can determine the transfer amount to be a total amount of the digital asset that the user has. The user can also provide user input at the client device to toggle and adjust the transfer amount, as described at least in reference to FIGS. 3A-3K. The transfer amount can also be determined before, during, or after one or more other blocks in the process 500 (such as after user input is received indicating a drop action of the digital asset in the bridge UI).

The client device can receive, at the client device, user input indicating a drag action of the selected representation of the digital asset from the first blockchain region across the bridge UI (block 512).

In block 514, the client device can determine, based on the user input, that a transfer of the digital asset is initiated from a first blockchain associated with the first blockchain region to another blockchain.

In reference to block blocks 512 and 514, the drag action can visually indicate the user's intent to transfer the digital asset from the first blockchain to another chain (or subnet, in some implementations). The user action further can simplify the user's interactions with underlying bridge technology provided by the backend computer system and which facilitates the transfer across chains.

Next, the client device can receive user input indicating a drop action of the selected representation of the digital asset in a second blockchain region of the bridge UI (block 516). The drop action can indicate final selection and user intent of selection of a destination chain for the digital asset transfer.

The client device can determine, based on the user input, that the transfer of the digital asset is initiated from the first blockchain to a second blockchain associated with the second blockchain region in the bridge UI (block 518).

In block 520, the client device can retrieve digital asset information, first blockchain information, and/or second blockchain information. Block 520 can be performed before, during, or after one or more other blocks of the process 500 described herein. The client device can retrieve the information by connecting to one or more APIs described further in reference to at least FIGS. 1A and 2. The information can also include wallet information, user information, and/or bridging protocol information. In some implementations, retrieving the information in block 520 can also include performing one or more checks to determine whether the user has sufficient resources (e.g., gas, digital asset transfer amount) to complete the desired transfer of the digital asset.

In block 522, the client device can determine, based on the retrieved information, transaction details. The client device can auto-populate the transaction details, as described herein.

Then, the client device can return, for presentation in the bridge UI, the transaction details (block 524). As described in reference to FIGS. 3A-3K, the transaction details can be presented in a modal window (e.g., pop out window) overlaying a portion of the bridge UI. The transaction details can be reviewed and approved by the user at the client device. At this point, the user may edit their selection of digital asset and source and destination chains. The user may also provide input to adjust or change the transfer amount. This operation can ensure that the user reviews and approves the transaction, minimizing any potential risk of errors.

Accordingly, the client device can receive user input indicating approval and/or modifications of the transaction details in block 526.

The client device can then generate and return, based on the user input, instructions to transfer the digital asset between the first and second blockchains (block 528). For example, the client device can submit the instructions to transfer to respective blockchain networks (block 530). As another example, the client device can return the instructions to a backend computer system as described herein that utilizes a bridge technology associated with the bridge UI to transfer the digital asset from the first blockchain to the second blockchain (block 532).

In block 534, the client device can return, for presentation in the bridge UI, information indicating completion of the transfer. Refer to FIGS. 3A-3K for further discussion.

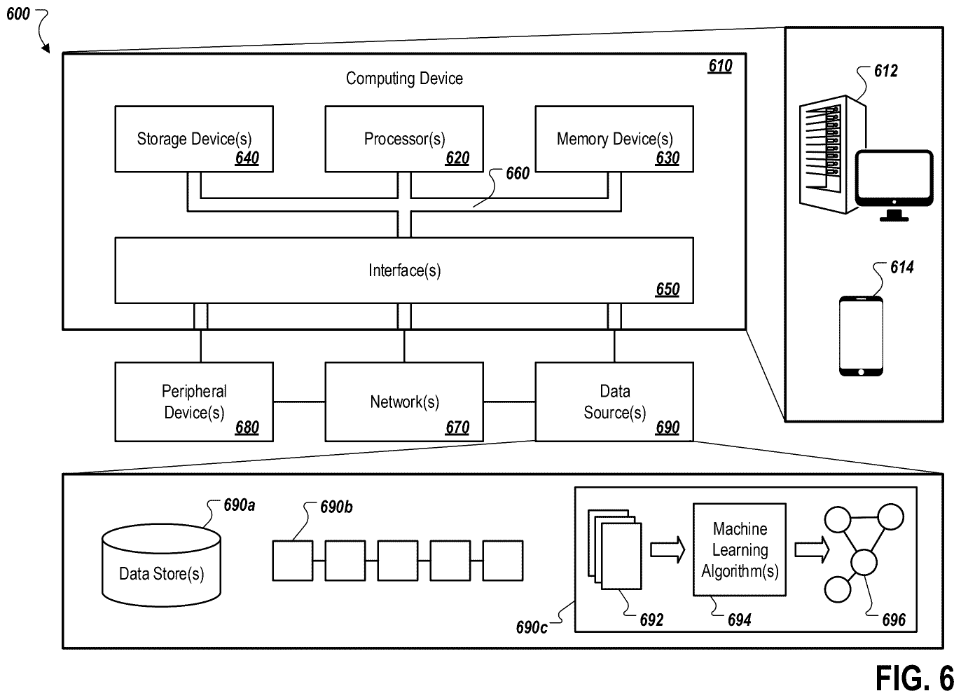

FIG. 6 is a schematic diagram that shows an example of a computing system 600 that can be used to implement the techniques described herein. The computing system 600 includes one or more computing devices (e.g., computing device 610), which can be in wired and/or wireless communication with various peripheral device(s) 680, data source(s) 690, and/or other computing devices (e.g., over network(s) 670). The computing device 610 can represent various forms of stationary computers 612 (e.g., workstations, kiosks, servers, mainframes, edge computing devices, quantum computers, etc.) and mobile computers 614 (e.g., laptops, tablets, mobile phones, personal digital assistants, wearable devices, etc.). In some implementations, the computing device 610 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 610, and an entire system can be made up of multiple devices communicating with each other. For example, the computing device 610 can be part of a computing system that includes a network of computing devices, such as a cloud-based computing system, a computing system in an internal network, or a computing system in another sort of shared network. Processors of the computing device (610) and other computing devices of a computing system can be optimized for different types of operations, secure computing tasks, etc. The components shown herein, and their functions, are meant to be examples, and are not meant to limit implementations of the technology described and/or claimed in this document.

The computing device 610 includes processor(s) 620, memory device(s) 630, storage device(s) 640, and interface(s) 650. Each of the processor(s) 620, the memory device(s) 630, the storage device(s) 640, and the interface(s) 650 are interconnected using a system bus 660. The processor(s) 620 are capable of processing instructions for execution within the computing device 610, and can include one or more single-threaded and/or multi-threaded processors. The processor(s) 620 are capable of processing instructions stored in the memory device(s) 630 and/or on the storage device(s) 640. The memory device(s) 630 can store data within the computing device 610, and can include one or more computer-readable media, volatile memory units, and/or non-volatile memory units. The storage device(s) 640 can provide mass storage for the computing device 610, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 650 can include various communications interfaces (e.g., USB, Near-Field Communication (NFC), Bluetooth, WiFi, Ethernet, wireless Ethernet, etc.) that can be coupled to the network(s) 670, peripheral device(s) 680, and/or data source(s) 690 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 650 can include a control interface that receives commands from an input device (e.g., operated by a user) and converts the commands for submission to the processors 620. The interface(s) 650 can include a display interface that includes circuitry for driving a display to present visual information to a user. The interface(s) 650 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 670 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 610 can communicate with the peripheral device(s) 680, the data source(s) 690, and/or other computing devices over the network(s) 670. In some implementations, the computing device 610 can directly communicate with the peripheral device(s) 680, the data source(s), and/or other computing devices.

The peripheral device(s) 680 can provide input/output operations for the computing device 610. Input devices (e.g., keyboards, pointing devices, touchscreens, microphones, cameras, scanners, sensors, etc.) can provide input to the computing device 610 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 610 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 690 can provide data for use by the computing device 610, and/or can maintain data that has been generated by the computing device 610 and/or other devices (e.g., data collected from sensor devices, data aggregated from various different data repositories, etc.). In some implementations, one or more data sources can be hosted by the computing device 610 (e.g., using the storage device(s) 640). In some implementations, one or more data sources can be hosted by a different computing device. Data can be provided by the data source(s) 690 in response to a request for data from the computing device 610 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 690a. The database(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in the database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 690b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 690c. The machine learning system(s) 690c, for example, can be used to analyze data from various sources (e.g., data provided by the computing device 610, data from the data store(s) 690a, data from the blockchain(s) 690b, and/or data from other data sources), to identify patterns in the data, and to draw inferences from the data patterns. In general, training data 692 can be provided to one or more machine learning algorithms 694, and the machine learning algorithm(s) can generate a machine learning model 696. Execution of the machine learning algorithm(s) can be performed by the computing device 610, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer- or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A method for transferring digital assets across networks using drag-and-drop functionality in a user interface (UI), the method comprising:
generating and executing, at a client device, instructions to present a bridge UI with drag-and-drop functionality enabled in a GUI display at the client device;
receiving, at the client device, user input indicating selection of a visual representation of a digital asset in a first network region of the bridge UI;
determining, by the client device and based on the user input indicating selection of the visual representation of the digital asset, a digital asset associated with a user to be transferred;
receiving, at the client device, user input indicating a drag action of the selected visual representation of the digital asset from the first network region of the bridge UI across another region of the bridge UI;
determining, by the client device and based on the user input indicating the drag action, that the user is initiating a transfer of the digital asset associated with the user from a first network associated with the first network region of the bridge UI;
receiving, by the client device, user input indicating a drop action of the selected visual representation of the digital asset in a second network region of the bridge UI;
determining, by the client device and based on the user input indicating the drop action, that the transfer of the digital asset associated with the user is initiated from the first network to a second network associated with the second network region of the bridge UI;
generating and returning, by the client device, instructions to execute the transfer of the digital asset associated with the user.

2. The method of claim 1, further comprising returning, by the client device and for presentation in the bridge UI, information indicating completion of the transfer of the digital asset associated with the user.

3. The method of claim 1, further comprising: determining, by the client device and based at least in part on the user input, transaction details for the transfer of the digital asset associated with the user.

4. The method of claim 3, further comprising:
returning, by the client device and for presentation in the bridge UI, the transaction details, wherein the transaction details are presented in a modal window that visually overlays at least a portion of the bridge UI;
receiving, by the client device, user input indicating approval of the transaction details; and
performing the generating and returning operation based on receiving the user input indicating approval of the transaction details.

5. The method of claim 3, wherein determining, at the client device and based at least in part on the user input, transaction details for the transfer of the digital asset associated with the user comprises:
accessing, using one or more APIs, digital asset information and user information;
performing, based on processing the accessed information, one or more checks to determine whether the user has sufficient resources to perform the transfer of the digital asset associated with the user; and
auto-populating, based on a determination that the user has the sufficient resources and further based on the accessed information, the transaction details.

6. The method of claim 1, wherein generating and returning, by the client device, instructions to execute the transfer of the digital asset associated with the user comprises returning the instructions to a backend computer system that is configured to use a bridge technology associated with the bridge UI to transfer the digital asset associated with the user from the first network to the second network.

7. The method of claim 1, further comprising: applying, by the client device, highlighting to a perimeter of the second network region in the bridge UI in response to receiving the user input indicating the drag action of the selected visual representation of the digital asset to the second network region in the bridge UI.

8. The method of claim 7, further comprising: removing, by the client device, the highlighting to the perimeter of the second network region in the bridge UI in response to receiving the user input indicating the drop action of the selected visual representation of the digital asset in the second network region in the bridge UI.

9. The method of claim 1 wherein generating and returning, by the client device, instructions to execute the transfer of the digital asset associated with the user comprises identifying a bridging protocol to bridge the first and the second networks, wherein the instructions include the identified bridging protocol.

10. The method of claim 1, wherein the digital asset is a token.

11. The method of claim 1, wherein the digital asset is a cryptocurrency.

12. The method of claim 1, wherein the first network and the second network are first and second blockchains.

13. The method of claim 1, wherein the first network and the second network are first and second subnets.

14. The method of claim 13, wherein the first and second subnets are part of a same blockchain.

15. The method of claim 13, wherein the first and second subnets are part of different blockchains.

16. The method of claim 1, wherein the first network is a blockchain and the second network is a subnet.

17. The method of claim 16, wherein the subnet is part of the blockchain.

18. The method of claim 16, wherein the subnet is part of a different blockchain.

19. The method of claim 1, wherein the first network is a subnet and the second network is a blockchain.

20. The method of claim 19, wherein the subnet is part of the blockchain.

21. The method of claim 19, wherein the subnet is part of a different blockchain.

22. The method of claim 1, wherein the user input comprises audio commands.

23. The method of claim 1, wherein the user input comprise touch feedback.

24. A method for transferring digital assets across networks using drag-and-drop functionality in a user interface (UI), the method comprising:
generating and executing, at a client device, instructions to present a bridge UI with drag-and-drop functionality enabled in a GUI display at the client device;
receiving, at the client device, first user input indicating selection of a visual representation of a first network in the bridge UI, a drag action of the selected visual representation of the first network across the bridge UI, and a drop action of the selected visual representation of the first network in a source network region of the bridge UI;
determining, by the client device and based on the first user input, a first network associated with a user from which to initiate a digital asset transfer;
receiving, at the client device, second user input indicating selection of a visual representation of a second network in the bridge UI, a drag action of the selected visual representation of the second network across the bridge UI, and a drop action of the selected visual representation of the second network in a destination network region of the bridge UI;
determining, by the client device and based on the second user input, a second network associated with the user for which to receive the digital asset transfer;
determining, by the client device and based at least in part on the first and second user input, transaction details for the transfer of the digital asset between the first network and the second network; and
generating and returning, by the client device and based on the transaction details, instructions to execute the transfer of the digital asset between the first network and the second network.

25. The method of claim 24, further comprising:
returning, by the client device and for presentation in the bridge UI, the transaction details;
receiving, by the client device, user input indicating approval of the transaction details; and
performing the generating and returning operation in response to receiving the user input indicating the approval of the transaction details.

26. The method of claim 25, wherein the transaction details are presented in a modal window that visually overlays at least a portion of the bridge UI.

27. The method of claim 24, further comprising returning, by the client device and for presentation in the bridge UI, information indicating completion of the transfer of the digital asset between the first network and the second network.
